(19) United States
(12) Patent Application Publication
(10) Pub. No.: US 2026/0247245 A1
(43) Pub. Date: Aug. 20, 2026

(54) CLIENT SIGNALING FOR INDICATING LINKS FOR TARGET ACCESS POINT FOR SEAMLESS ROAMING

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 19/543,336

(22) Filed: Feb. 18, 2026

Related U.S. Application Data
(60) Provisional application No. 63/759,908, filed on Feb. 18, 2025.

(51) Int. Cl. H04W 36/18; H04W 36/16; H04W 36/30

(52) U.S. Cl. CPC H04W 36/185; H04W 36/165; H04W 36/30

(57) ABSTRACT

Client signaling for indicating links for a target Access Point (AP) to use for seamless roaming may be provided. A target AP establishes one or more links with a client device for roaming to the target AP, wherein the links are configured in a power save mode by default. The target AP receives signaling indicating availability of a link of the one or more links for transmissions to the client device. The target AP determines, based on the signaling, when the link is available for transmissions and initiates one or both of downlink transmissions and triggered uplink transmissions to the client device on the link after determining the link is available.

### RELATED APPLICATION

Under provisions of 35 U.S.C. § 119(e), Applicant claims the benefit of and priority to U.S. Provisional Application No. 63/759,908, filed Feb. 18, 2025, the disclosure of which is incorporated herein by reference in its entirety.

### TECHNICAL FIELD

The present disclosure relates generally to providing client signaling for indicating links for a target Access Point (AP) to use for seamless roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for client signaling to target Access Points (APs) for seamless roaming in accordance with aspects of the present disclosure.

FIG. 2 illustrates a seamless roaming process in accordance with aspects of the present disclosure.

FIG. 3 is a message exchange diagram illustrating a procedure for client signaling to target APs for seamless roaming in accordance with aspects of the present disclosure.

FIG. 4 is a flow diagram illustrating a method for client signaling to target APs for seamless roaming in accordance with aspects of the present disclosure.

FIG. 5 is a block diagram of a computing device in accordance with aspects of the present disclosure.

FIG. 6 is a block diagram of a communications device in accordance with aspects of the present disclosure.

### DETAILED DESCRIPTION

### Overview

Client signaling for indicating links for a target Access Point (AP) to use for seamless roaming may be provided. A target AP establishes one or more links with a client device for roaming to the target AP, wherein the links are configured in a power save mode by default. The target AP receives signaling indicating availability of a link of the one or more links for transmissions to the client device. The target AP determines, based on the signaling, when the link is available for transmissions and initiates one or both of downlink transmissions and triggered uplink transmissions to the client device on the link after determining the link is available.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

As used herein an Access Point (AP) can be a Multi-Link-Device (MLD). Therefore, AP and AP MLD as used should be understood to encompass both non-MLDs and MLDs. Similarly, a client device can be a MLD in various embodiments. Reference to a client device should be understood to encompass both non-MLDs and MLDs. Furthermore, the recitation at least one of A and/or B, one or more of A and/or B, or the like as used herein indicates at least one of A only, at least one of B only, or at least one of both A and B.

Roaming in Wi-Fi networks occurs when a client device (e.g., a Station (STA)) transitions its connection from one AP to another AP, typically because the client device has moved outside the range of its current AP or has identified another AP that can provide a better connection. Roaming decisions are primarily made by client devices based on Received Signal Strength Indicator (RSSI) measurements, supplemented by network recommendations from the serving AP regarding suitable neighbor APs.

Seamless roaming techniques have been developed to reduce roaming latency and improve user experience during AP transitions. Non-MLD seamless roaming techniques include those described in IEEE 802.11k, which reduces the time required to roam by enabling a client to more quickly determine which AP it should roam to next, with the current AP providing information regarding neighboring APs and their channels. Another non-MLD technique is described in IEEE 802.11r, which uses Fast Basic Service Set (BSS) Transition (FT) to allow encryption keys to be stored on all of the APs in a network, enabling a client to avoid performing the complete authentication process to a backend server every time it roams to a new AP within the network, thus reducing authentication-related latency.

MLD-based seamless roaming as defined in the IEEE 802.11bn amendment introduces Seamless Mobility Domains (SMDs), which are logical, secure groupings of multiple AP MLDs that enable client devices to roam between them without disconnecting, re-authenticating, or experiencing packet loss. MLD-based seamless roaming enables a “make-before-break” approach where a device establishes a connection to a new AP before releasing the old one by utilizing multiple links. The IEEE 802.11bn seamless roaming procedures include a roaming preparation phase during which the client device and serving AP exchange signaling to prepare one or more target APs for the upcoming roaming transition, followed by a roaming execution (and/or roaming transition) phase during which the actual transition to the target AP occurs. The roaming preparation phase may include negotiation of target APs, establishment of security associations with target APs, and preparation of link configurations, enabling the subsequent roaming execution to occur with minimal latency and data loss.

When performing seamless roaming operations, a client can add links with a target AP MLD as part of roaming preparation and/or roaming execution/transition procedures. For example, this can be achieved using Link Reconfiguration Request/Response frames defined in IEEE 802.11be, with enhancements for adding links. For existing seamless roaming operation, all added links are considered to be in power save mode by default (with Power Management (PM) set to 1 to indicate the respective link is in power save mode), with power state being in the doze state as per rules defined in IEEE 802.11be for added links. This default behavior means that the target AP MLD requires signaling from the client to determine when downlink (DL) transmissions can begin on the added links.

However, the appropriate timing for when a client can receive DL transmissions from a target AP MLD varies depending on operational circumstances. In some cases, a client may be able to receive DL transmissions from the target AP MLD immediately after roaming execution is completed, such as when the target AP MLD has a link operating on the same channel as one of the links of the current AP MLD. In other cases, the client needs to reconfigure its radio resources to start listening to one or more links of the target AP MLD before it can start receiving DL transmissions, particularly when the target AP MLD operates on a different set of channels than the current AP MLD. This radio resource reconfiguration requires a transition time period. Additionally, in some scenarios, a client may not be ready to receive all Traffic Identifiers (TIDs) or Access Categories (ACs) from the target AP MLD because it is still fetching data from the current AP MLD for certain TIDs/ACs.

Because the target AP MLD is not aware of when the client is ready to begin receiving transmissions over the added links, inefficiencies arise that undermine the seamless nature of the roaming operation. If the target AP MLD attempts DL transmissions before the client is ready to receive them, the client device may not correctly receive transmissions from one or both of the current or serving AP and the target AP, resulting in inefficiencies, unnecessary overhead, interference, or other undesirable operation. Moreover, to minimize roaming time and maintain seamless connectivity, it is desirable for the client to start uplink (UL) and DL transmissions with the target AP MLD as soon as the client is ready.

The present disclosure addresses this issue by providing client signaling mechanisms that indicate when links with the target AP MLD can be used for communication. In various embodiments, a client can signal: (1) that the target AP MLD should not send any DL transmissions on any links until the client provides explicit signaling indicating readiness; (2) one or more specific links on which the client will be available for receiving DL transmissions after roaming execution, optionally with a transition time period; (3) availability through uplink (UL) transmissions sent from the client to the target AP MLD after roaming execution; and (4) specific TIDs or ACs for which the client is ready to receive DL transmissions from the target AP MLD. Default behaviors for situations where explicit client signaling is not provided are also described. These client signaling capabilities improve seamless roaming operation by enabling the target AP MLD to begin DL transmissions at the appropriate time, thereby reducing roaming latency, avoiding wasted transmission attempts, and maintaining seamless connectivity during the roaming process.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or,” “and/or,” “at least one of,” and “one or both of” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

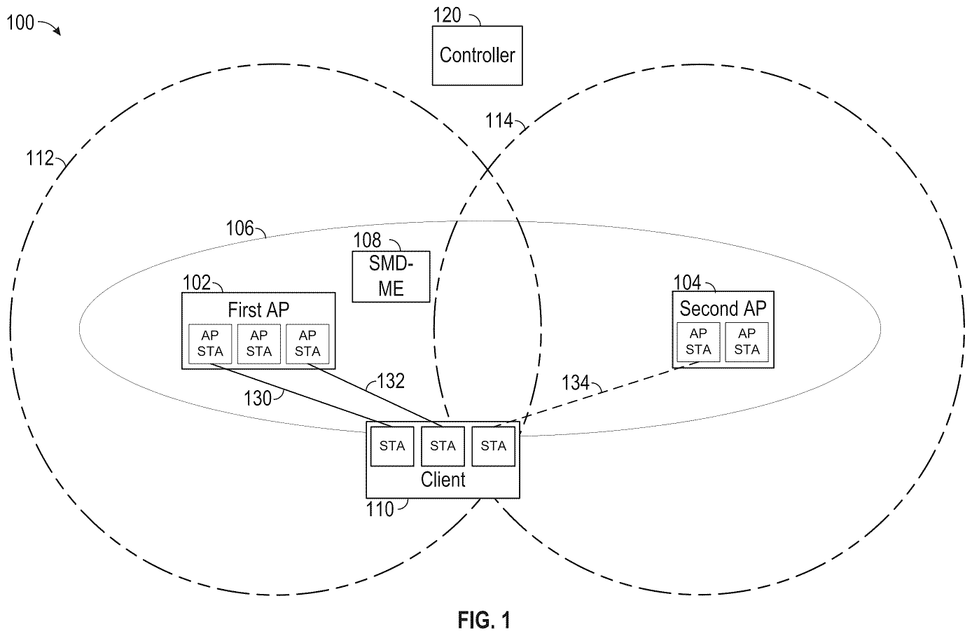

FIG. 1 is a block diagram of an operating environment 100 for client signaling to target APs for seamless roaming. In the illustrated embodiment, the operating environment 100 includes a first AP 102, a second AP 104, a client device 110, and a controller 120. The first AP 102 has a service area or cell indicated by the first cell 112, and the second AP 104 has a service area indicated by the second cell 114. The range of the first AP 102 and the second AP 104 may extend past the boundaries of the associated cells, resulting in overlapping coverage, but the signals grow weaker as devices move away from the respective APs. Thus, the first AP 102 and the second AP 104 may fail to communicate reliably with devices some distance past the edges of the associated cells. The edges of the first cell 112 and the second cell 114 as shown in the operating environment 100 are examples and may be different in other implementations (e.g., different sizes, shapes, etc.).

The APs in the operating environment 100 are grouped into one or more SMDs, such as the SMD 106 in the illustrated embodiment. The SMD 106 provides seamless roaming to clients across AP MLDs within the SMD 106. A client device 110 associates at the SMD level with a SMD-Management Entity (ME) within the SMD 106 and then roam between AP MLDs within the SMD without performing reauthentication or reassociation, to achieve seamless roaming. The first AP 102 and second AP 104 are part of the same SMD 106.

The client device 110 is any device that connects to the network to communicate with other devices on the network, such as a smartphone, a tablet, a personal computer, a laptop, an Internet of Things (IoT) device, and/or the like. As illustrated in FIG. 1, the client device 110 is currently associated with the SMD 106 (e.g., via the SMD-ME 108), within the first cell 112, and connected with the first AP 102. However, the client device 110 may be moving toward the boundary of the first cell 112 and into the second cell 114, indicating that the client device 110 may soon need to roam from the first AP 102 to the second AP 104 or another neighbor AP to maintain network connectivity and quality of service (QoS).

An AP, such as the first AP 102 and the second AP 104, is generally a fixed station that communicates with client devices and may also be referred to as a base station, wireless device, or some other terminology. The APs may support seamless roaming procedures (e.g., as defined in the IEEE 802.11bn amendment), including roaming preparation and roaming execution (or roaming transition) phases, that enable the client device 110 to transition between APs (e.g., AP MLDs) within the same SMD 106 with reduced roaming latency and data loss. In some embodiments, the first AP 102 and the second AP 104 are in a same SMD, enabling seamless roaming between them without the client device 110 needing to disconnect, re-authenticate, re-associate, or experience packet loss.

The controller 120 may be any network controller (e.g., a WLAN controller) and may manage the first AP 102, the second AP 104, the SMD 106, the SMD-ME 108, and/or other network devices (not shown) to allow wireless devices such as the client device 110 to connect to the network. In some embodiments, the operations of the controller 120 described herein may be performed by one or more of the first AP 102, the second AP 104, and/or another device, and vice versa. In some embodiments, for example, the controller 120 is included within or integrated with an AP and coordinates the links formed by that AP. In some embodiments, the controller 120 is separate from the APs and coordinates the links of multiple APs. The operating environment 100 is an example configuration and there may be a different number of clients, APs, controllers, and/or other devices in further examples.

As used herein, an AP along with the client devices associated with the AP (e.g., the client devices within the coverage area or cell of the AP) may be referred to as a basic service set (BSS). In the illustrated example, the first AP 102 is the serving AP for the client device 110 within the first cell 112. The APs may communicate with one or more client devices on the downlink (DL) and uplink (UL). The DL is the communication link from an AP to a client device 110, and the UL is the communication link from a client device 110 to an AP. In some cases, a client device 110 may also communicate peer-to-peer with another client device.

As shown in FIG. 1, the client device 110 and the APs are MLDs and each include one or more STAs. The client device 110 uses the STAs to form links with the AP STAs. For example, the client device 110 may use a first STA to form a first wireless link 130 with a corresponding STA of the first AP 102, and the client device 110 may use a second STA to form a second wireless link 132 with another STA of the first AP 102. Each STA may include Physical (PHY)-layer and lower-Media Access Control (MAC) components. The MLDs may also include an upper-MAC for coordinating the multiple STAs (or links) that are part of the MLD. The STAs can use different frequency bands for various wireless links. For example, the first wireless link may be formed using a 5 GHz band and the second wireless link may be formed using a 6 GHz band. Note, however, that these are merely example frequency bands and that the wireless links may use any suitable frequency bands, including 2.4 GHz, 5 GHz, 6 GHz, or other bands.

In general, the AP(s) and the client device 110 may form any suitable number of links for communication using any suitable frequencies. In some instances, the client device 110 may form links with one AP (e.g., the first link 130 and the second link 132 with the first AP 102). In other instances, the client device 110 may form links with multiple APs (e.g., the first link 130 and the second link 132 with the first AP 102 and a third link 134 with the second AP 104). As a result, the client device 110 may communicate with one or more APs over multiple links using different frequencies. Additionally, setup links may not always be active or otherwise useable. For example, the third link 134 may be setup with the second AP 104 as part of roaming preparation, but the roaming execution may not have occurred yet. After roaming execution to the second AP 104, the third link 134 can be used; however, the client device 110 may not have indicated to the second AP 104 that the client device 110 is ready to use the third link 134. Thus, the target AP may be waiting to use the third link 134 for a transition period (e.g., to allow the client device 110 to configure its radio resources), waiting until it receives an indication from the client device 110, or the like.

The controller 120 may provide coordination and control for the APs. For example, the controller 120 may handle adjustments to radio frequency power, channels, authentication, association, and security for the APs. The controller 120 may also coordinate the links formed by the client device(s) 110 with the APs. For example, the controller 120 may coordinate when the client device 110 and an AP communicate over a link using a particular frequency, the type of data communicated over a particular link, when the client device 110 and the AP form or terminate certain links, and/or when the client device 110 and AP (pre)-associate with each other to (pre)-establish certain links.

The client device 110 may be referred to as a STA MLD or non-AP MLD (e.g., a STA or client device acting as an MLD) and the first AP 102 or second AP 104 may be referred to as an AP MLD (e.g., an AP that acts as an MLD). The STA MLD and AP MLD are generally representative of any device capable of performing multi-link (ML) operations. A MLD may generally be classified based on whether it is a single radio MLD or multi-radio MLD. Single radio MLDs generally use a single radio (e.g., STA) to switch between one or more links. One category of single radio MLDs is Enhanced Multi-Link Single Radio (eMLSR). eMLSR devices generally operate one main wireless radio that can transmit and/or receive data frames on a given link, but can listen in low capability on a set of links when the device is not actively transmitting or receiving. Multi-radio MLDs may generally be classified into the following two types: (i) simultaneous transmission and reception (STR) MLD and (ii) non-STR MLD. For STR MLDs, a transmission on one link does not affect the operations of frame reception and clear channel assessment (CCA) on other links. Stated differently, for STR MLDs, individual links can operate independently of each other. For non-STR MLDs, the operation on one link may be restricted by the operation on another link. For example, a transmission on one link may not be allowed if it will cause reception interruption on another link, or a reception or CCA on one link may not be allowed if a transmission is ongoing on another link.

In certain embodiments, the operating environment 100 enables the client device 110 to utilize improved seamless roaming techniques that address timing coordination for when links with a target AP MLD become useable for communication. As described above, when links are added with a target AP MLD (such as the second AP 104) during roaming preparation or roaming execution, these links are in power save mode by default, with the power state in the doze state. Without appropriate signaling from the client device 110, the target AP MLD does not know when it can begin DL transmissions to the client device 110 on the links that are added for the client device 110, which can result in inefficient operation and undermine seamless connectivity.

The techniques described herein enable the client device 110 to provide signaling to a target AP MLD to indicate when one or more links are ready for use. In some embodiments, the client device 110 may signal during roaming preparation or roaming execution that the target AP MLD should not send any DL transmissions until the client device 110 provides explicit signaling indicating readiness. In other embodiments, the client device 110 may indicate one or more specific links that will be available for receiving DL transmissions after roaming transition (or roaming execution) is completed, optionally with a transition time period during which the client device 110 will reconfigure its radio resources. In further embodiments, the client device 110 may signal availability of links through UL transmissions sent to the target AP MLD after roaming execution, such as UL QoS data frames or UL QoS null frames that indicate power management state changes for one or more links to signal that links are available for DL/UL exchange, or through management frames sent to the target AP that confirm the roaming execution and indicate which links are ready. In the UL transmissions sent to the target AP (the UL QoS data frames, UL QoS null frames or UL management frames), the client device 110 may indicate which links are available and out of power save mode by setting PM=0 and can use cross-link PM signaling (in A-Control field of the MAC header) to signal PM state changes for multiple links. In still further embodiments, the client device 110 may signal specific Traffic Identifiers (TIDs) or Access Categories (ACs) for which it is ready to receive DL transmissions from the target AP MLD, enabling granular control over when different types of traffic can be received.

These client signaling capabilities enable the target AP MLD to coordinate DL transmissions appropriately, beginning communication when the client device 110 is ready to receive, thereby reducing roaming latency, avoiding wasted transmission attempts, and maintaining seamless connectivity during the roaming process. The specific signaling mechanisms and procedures for these embodiments are described in further detail below with reference to subsequent figures.

In certain embodiments, the operating environment 100 may enable the client device 110 to utilize seamless roaming techniques such as roaming without performing re-association with one or more APs, receiving neighbor reports to determine a target AP, and so on. In certain embodiments, as the client device 110 moves away from the coverage of an AP, the client device 110 may perform roaming preparation procedures to add links with a target AP MLD as it roams in the coverage of target APs within the SMD 106 to continue connectivity with the network. In certain embodiments, the beacons'signal strength (e.g., RSSIs) from APs in the client device 110 roaming path acts as triggers for initiating roaming preparation to add links with target AP MLD(s).

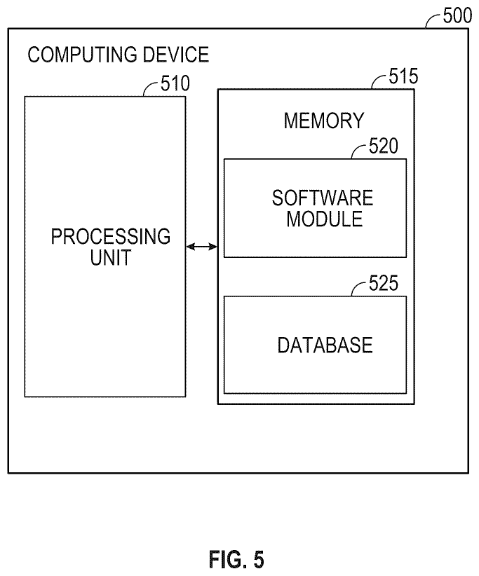

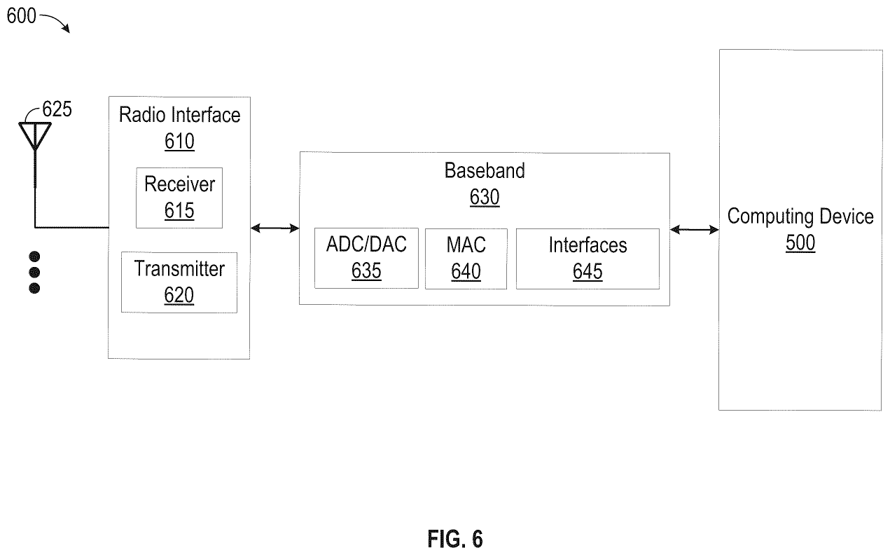

The elements described above of the operating environment 100 (e.g., the first AP 102, the second AP 104, the client device 110, the controller 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 5 and 6, the elements of the operating environment 100 may be practiced in a computing device 500 and/or communications device 600.

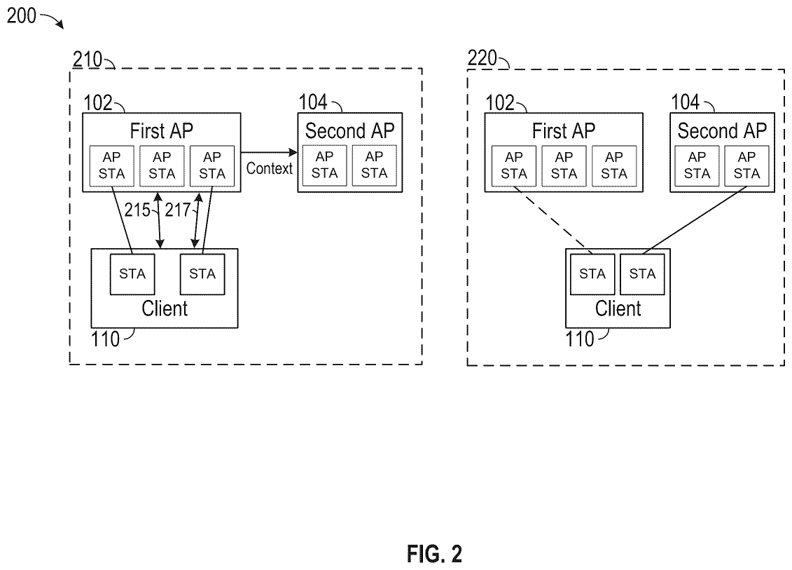

FIG. 2 illustrates an example seamless roaming process 200 with the client device 110 roaming from the first AP 102 (serving AP) to the second AP 104 (target AP) (e.g., within the SMD 106). The seamless roaming process includes a roaming preparation procedure and roaming execution procedure. The roaming preparation procedure involves coordination between serving AP MLD and one or more target AP MLDs, to add one or more links at the target AP MLD(s) and reserve resources at the target APM MLD(s) (such as SCS and Block Acknowledge resources). After roaming preparation is complete, the client device 110 then performs roaming execution to complete its roaming execution. The two phases of roaming procedure minimize connection disruption during roaming and provides faster and more seamless roaming.

Roaming preparation and execution is shown in phase 210. During the phase 210, the client device 110 and the first AP 102 perform a SMD BSS transition (ST) preparation exchange 215. The ST preparation exchange 215 includes an ST preparation request sent from the client device 110 to the first AP 102, indicating that the client device 110 intends to roam to one or more target APs and requests to prepare links on those target APs. In response to the ST preparation request, the first AP 102 sends context related to the client device 110 to the second AP 104 and potentially other target APs. The context transferred may include parameters related to block acknowledgement agreements setup for the client device 110, stream classification service (SCS) streams setup for the client device 110, mirrored SCS (MSCS) streams setup for the client device 110, target wake time (TWT) agreements setup for the client device 110, TID-to-link mapping (TTLM) agreements setup for the client device 110, security association context associated with the client device 110, capabilities of the client device 110, and/or other context information.

The ST preparation exchange 215 further includes an ST preparation response sent from the first AP 102 to the client device 110 indicating whether the roaming preparation request succeeds, for example indicating whether one or more target APs accept the roaming preparation request. If at least one target AP accepts the roaming request (the second AP 104 in the illustrated embodiment), the preparation procedure in phase 210 is considered successful. The ST preparation exchange 215 can further include additional ST requests, context transfers, and ST responses if the roaming request fails or to provide multiple options to the client device 110. The roaming preparation procedure can include any operations described in various IEEE 802.11 specifications and amendments, including the IEEE 802.11bn amendment.

Following successful completion of the ST preparation exchange 215, the first AP 102 and the client device 110 can perform a roaming execution procedure to enable the client device 110 to transition to the second AP 104. Roaming execution involves client device 110 performing an ST execution exchange 217 with the first AP 102. The ST execution exchange 217 completes the roaming execution to the second AP 104. In some embodiments, the roaming execution exchange can also be performed directly with the target AP (not shown in FIG. 2). In this case, any signaling provided as part of roaming execution request to indicate link availability from the client device 110 is sent directly to the target AP in the roaming execution request.

After roaming execution is completed, the client device 110 enters a roaming transition phase 220. In the roaming transition phase 220, the client device 110 has established at least one link with the second AP 104 (the target AP) and may maintain at least one link with the first AP 102. 102 to perform download of buffered DL data at the first AP 102. During this phase, although the client device 110 has established links with the second AP 104, the second AP 104 still needs to be signaled when those links can be used for DL and triggered UL transmissions since the client device may not be ready to use those links yet. In one embodiment, during the roaming transition phase 220, the client device may be connected to only one AP at a time (e.g., a single radio client device). Also, a single radio client device 110 may perform sequential operation with the first AP 102 and the second AP 104, where the client device 110 first performs download of any buffered DL data from the first AP 104 and then fully transitions all its links to the second AP 104 (the target AP for the roam). In some embodiments, during the roaming transition phase 220, the client device 110 may be going back and forth between the links of the first AP 102 and the second AP 104. In yet another embodiment, during the roaming transition phase 220 the client device 110 may be connected to both the first AP 102 and the second AP 104 simultaneously (e.g., if the client device is a multi-radio device).

The embodiments described below enable the client device 110 to signal to the target AP MLD (second AP 104) when links are ready for DL transmissions and triggered UL transmissions after roaming execution is completed, addressing the timing coordination problem described above. These signaling mechanisms can be employed during the roaming preparation procedure, during the roaming execution procedure, or during the roaming transition phase 220, depending on the specific embodiment.

### Signaling to Defer DL (and Triggered UL) Transmissions Until Client Indicates Readiness

In certain embodiments, the client device 110 can indicate in a roaming request that the target AP (e.g., the second AP 104) should not send any DL transmissions (and triggered UL) on any of the links with the target AP until the target AP receives an UL transmission from the client device 110 signaling readiness of one or more links to receive DL transmissions. The roaming request may be, for example, an ST preparation request, an ST execution request, or another roaming request. The target AP can receive the signal information from the serving AP (first AP 102) via context transfer during the preparation phase 210. The ST preparation request and ST execution request may be the UHR Link Reconfiguration Request frame (e.g., with a specific Type value) in example implementations.

The client device 110 can signal this information using various techniques. In one implementation, the client device 110 uses a field (e.g., a 1-bit or 2-bit field) in the roaming request indicating power save mode (PM=1 and in doze state) for all added links, which signals that the links are not available for DL transmissions (and triggered UL transmissions) after roaming transition (or roaming execution) is completed. In another implementation, the client device 110 uses a link ID bitmap field (e.g., an available links bitmap) that signals (typically via a bit in the bitmap set to 0) that one or more links are not available (or available) after roaming execution. In yet another implementation, the client device 110 signals through a field in the Reconfiguration ML element that each added link is in power save mode (PM=1) and in doze state.

After the roaming execution, the client device 110 sends an UL transmission to the target AP MLD to indicate when one or more links become available for DL transmissions and triggered UL transmissions. In some embodiments, the UL transmission is an UL QoS data frame that signals which links are out of power save mode (e.g., PM=0). The UL QoS data frame may be sent via the link that is now available. In addition, the UL QoS data frame can also indicate additional links that are now available using cross-link PM indication signaling (e.g., in an A-Control field in the MAC header). In other embodiments, the UL transmission is an UL QoS null frame signaling PM=0 mode for one or more links of the target AP MLD, for example using cross-link PM indication signaling in an A-Control field. The A-Control field signaling can also be included in the MAC header of management frames transmitted in UL, including action frames, enabling the client device 110 to signal power management state changes for multiple links within UL management frame transmissions. In further embodiments, the UL transmission is a roaming confirmation management frame (or another management frame or action frame) that confirms that the client device 110 has roamed to the target AP MLD and indicates which links are ready for DL transmissions and triggered UL transmissions. The roaming confirmation management frame may be a UHR defined management/action frame which is transmitted as a protected management frame from the client device 110 to the target AP. For example, this frame can be a UHR Link Reconfiguration Notify frame (e.g., with a specific Type value) which indicates to the target AP that client device 110 has fully roamed to the target AP, signaling that target AP can now transmit DL and triggered UL transmissions to the client device 110. The roaming confirmation management frame can also indicate set of links which are no longer in power save mode by indicating PM=0 for those links, using PM signaling for current link and cross-link PM signaling for other links (e.g. in the A-Control field in the MAC header of the management frame).

In certain embodiments involving sequence number (SN) continuity, when the client device 110 has completed DL data drain with its current or serving AP MLD (e.g., the first AP 102), the client device 110 transmits a roaming configuration management frame, such as an ultra-high reliability (UHR) Link Reconfiguration Notify frame, to the target AP MLD (e.g., the second AP 104) to signal completion of the DL data drain. SN continuity refers to the case where the SNs assigned to downlink transmissions (e.g., MAC Protocol Data Units (MPDUs)) continue from the serving AP MLD to the target AP MLD rather than resetting on the target AP. For example, if the serving AP MLD transmitted MPDUs with SNs 1 through 100, the target AP MLD would continue with SNs 101 and higher. In this configuration, the client device 110 maintains a single extended receive buffer for receiving downlink MPDUs from both the serving AP MLD and the target AP MLD during the roaming transition. This extended receive buffer enables the client device 110 to properly order and process MPDUs regardless of which AP MLD transmitted them, avoiding duplication and ensuring proper delivery to the upper-layers.

When SN continuity is maintained at the target AP MLD, the target AP MLD cannot transmit DL data to the client device 110 unless it receives the roaming confirmation management frame (e.g., a UHR Link Reconfiguration Notify frame) from the client device 110. This requirement ensures that the client device 110 has completed receiving buffered data from the serving AP MLD before the target AP MLD begins transmissions, preventing SN conflicts and maintaining proper ordering of MPDUs, avoiding duplicate and out-of-order delivery to the upper-layers.

In contrast, if SNs are reset at the target AP MLD (starting from zero), the target AP MLD can transmit DL data to the client device 110 on a link that is not in power save mode without requiring the roaming confirmation management frame (e.g. a UHR Link Reconfiguration Notify frame) to be received from the client device 110. In this scenario, the client device 110 maintains separate receive buffers for the serving AP MLD and the target AP MLD. The separate buffers enable the client device 110 to independently track and process MPDUs from each AP MLD without SN conflicts. However, by default all added links on the target AP MLD are in power save mode, so the client device 110 must indicate the links are out of power save mode (PM=0) for one or more of the added links before the target AP MLD can transmit DL data on those links. The client device 110 can indicate the PM state through various UL transmissions, including QoS data frames, QoS null frames, or management frames (such as a roaming confirmation management frame as described above).

In the roaming confirmation management frame (e.g. the UHR Link Reconfiguration Notify frame) sent by the client device 110 to the target AP MLD, an A-Control field can be included in the MAC header. In the A-Control field, the client device 110 indicates PM state for the links with the target AP MLD using cross-link PM indication through the ML Power Management (MLPM) Control field included in the A-Control. The cross-link PM indication enables the client device 110 to signal from one link that other links are no longer in power save mode. Additionally, in the roaming confirmation management frame (e.g. the UHR Link Reconfiguration Notify frame), the client device 110 can indicate PM=0 for the link where it is sending the frame by setting the PM bit in the MAC header to 0.

### Signaling Specific Links Available for DL Transmissions

In some embodiments, the client device 110 can indicate in a roaming request to the target AP one or more links that will be useable for DL transmissions and triggered UL transmissions after the roaming transition/execution is complete. The roaming request may be, for example, an ST preparation request, an ST execution request, or another roaming request. The indication may be provided through the serving AP (first AP 102) during the roaming preparation or roaming execution may be provided directly to the target AP during roaming execution via the target AP. For example, if the client device 110 is setting up the links with the target AP, the client device 110 can indicate that one or more of the links will be immediately available for DL transmissions in the roaming request. The target AP can receive the signal information from the serving AP via context transfer in example implementations.

The client device 110 can signal this information using various techniques. In one implementation, the client device 110 uses a link ID bitmap field (e.g., an available links bitmap) that signals which links are available after roaming execution for DL transmissions and triggered UL transmissions, typically via bit(s) in the bitmap for the available link(s) being set to 1. In another implementation, the client device 110 uses a field in a Reconfiguration ML element that signals that one or more added links are available with PM=0 (and not in power save mode). In yet another implementation, the client device 110 sends specific Link IDs that are available for DL transmissions and triggered UL transmissions after the roaming execution completes.

The client device 110 can optionally indicate a transition time period indicating that one or more links will only be ready after this period. The transition time period accounts for the time needed by the client device 110 to reconfigure its radio resources to listen to the links of the target AP MLD, particularly when the target AP MLD operates on a different set of channels than the serving AP MLD. The target AP can delay DL transmissions and triggered UL transmissions until after the indicated transition time period, for example beginning after sending the roaming execution response. The transition time period can be indicated in a separate field in the roaming request. The transition time period may be signaled as a single value for all links or as individual values per link, enabling more granular control over when different links become available.

### Combined Signaling for Multiple Links with Different Availability

In certain embodiments, the client device 110 has the flexibility to combine the signaling approaches described above for different links with the target AP MLD. Specifically, the client device 110 can signal to defer DL transmissions until the client device 110 indicates readiness for one or more links while simultaneously signaling that one or more other links are available for DL transmissions (either immediately or after a transition time period). This combined approach enables the client device 110 to provide granular per-link availability information that reflects the operational circumstances of each link.

For example, the client device 110 may signal in a roaming request that a first link with the target AP MLD operating on the same channel as a link with the serving AP MLD is immediately available (or available after a transition time period) for DL transmissions and triggered UL transmissions (using an available links bitmap with the bit for the first link set to 1), while also signaling that a second link with the target AP MLD operating on a different channel will require explicit UL signaling before DL transmissions and triggered UL transmissions can begin (using the available links bitmap with the bit for the second link set to 0, or through a field indicating the second link is in power save mode with PM=1 and in doze state). This flexibility allows the target AP MLD to begin DL transmissions and triggered UL transmissions on the first link immediately (or more quickly) while waiting for the client device 110 to complete radio reconfiguration and/or other operations and send an UL transmission indicating readiness for the second link.

In some implementations, the client device 110 can also specify a transition time period for one or more links that are signaled as available, indicating that those links will be ready after the specified period, while other links require explicit UL signaling with no predetermined availability time. The client device 110 can use various combinations of the signaling mechanisms described above, including link ID bitmaps, fields in the Reconfiguration ML element, and transition time period fields, to convey different availability states for different links, providing the target AP MLD with comprehensive information about when each link can be used for DL transmissions and triggered UL transmissions.

### Signaling Specific TIDs or ACs Ready for Reception

In additional embodiments, the client device 110 indicates the specific set of TIDs and/or ACs that it is ready to receive from the target AP MLD rather than just indicating available links. The client device 110 may indicate specific TIDs or ACs because, in some cases, the client device 110 may not be ready to receive all TIDs and/or ACs from the target AP. For example, the client device 110 may still be receiving data from the serving AP (first AP 102) for some TIDs and/or ACs and may not want the target AP to send DL transmissions for those TIDs/ACs yet to avoid conflicts or out-of-order delivery. Therefore, the client device 110 can signal to the target AP the set of TIDs and ACs it is ready to receive in a frame sent to the target AP. In some implementations, the client device 110 also signals to the target AP one or more links over which it can receive the indicated TIDs or ACs using PM mode signaling for the same link or cross-link.

The scenarios where the client device 110 is not ready to receive all TIDs or ACs from the target AP MLD may arise in different client implementations. In some embodiments, the client device 110 is a dual radio device with one radio maintaining connectivity with the serving AP MLD (first AP 102) while another radio establishes connectivity with the target AP MLD (second AP 104). In this dual radio configuration, the client device 110 can simultaneously drain buffered DL data for certain TIDs/ACs from the serving AP MLD on one radio while beginning to receive other TIDs/ACs from the target AP MLD on the other radio.

In other embodiments, the client device 110 is a single radio device that switches back and forth between the serving AP MLD and the target AP MLD. In this configuration, the client device 110 may switch to the serving AP MLD to drain buffered DL data or send UL data for certain TIDs/ACs, then switch to the target AP MLD to receive DL data or send UL data for other TIDs/ACs. This switching behavior necessitates granular TID/AC-level signaling to inform the target AP MLD which traffic types the client device 110 is ready to receive in DL or be triggered for transmitting in UL at any given time.

In certain implementations, the client device 110 can indicate the list of TIDs and ACs that it is ready to receive (or be triggered for) in an UL QoS data frame or UL QoS null frame as part of an A-Control field. The A-Control field could include a TID bitmap (8 bits or 16 bits long) where each bit corresponds to a TID and is set to 1 to signal that the client device 110 is ready to receive DL transmissions for that TID. Alternatively, the field could be an AC bitmap indicating ACs for which the client device 110 is ready to receive data from the target AP, such as a 4-bit AC bitmap. As another alternative, the client device 110 can indicate the highest TID or AC for which the client device 110 can receive data (instead of a TID/AC bitmap), consuming 3 or 4 bits for TID indication or 2 bits for AC indication.

In some implementations, the client device 110 can send a TTLM Request frame that signals the set of TIDs (and mapped links) that the client device 110 is ready to receive from the target AP MLD. If the client device 110 is not ready to receive all the TIDs from the target AP MLD, then the client device 110 can signal a subset of TIDs and the link(s) where DL/UL data for those TIDs can be exchanged in the TTLM Request frame. The target AP MLD does not transmit DL traffic for the TIDs that are not indicated in the signaling to the client device 110 until it receives revised signaling either in-band (e.g., in an A-Control field) or in a management frame (e.g., in a TTLM Request frame or another management frame) that indicates that the client device 110 is ready to receive MPDUs for those TIDs. In the TTLM Request frame, the client device 110 can indicate in the A-Control field the PM state for the links with the target AP MLD to signal that one or more links which are now available DL and UL exchange for the TIDs indicated in the frame.

In further embodiments, the client device 110 may signal the set of TIDs or ACs it is ready to receive from the target AP MLD another management or action frame (e.g., in a UHR Link Reconfiguration Notify frame) that the client device 110 sends to the target AP MLD to signal completion of DL data drain. The client device 110 can include a list of TIDs or ACs (e.g., as a TID bitmap field or list of TIDs) for which the client device 110 has completed DL data drain with the serving AP MLD and is ready to receive DL data (and triggered UL) from the target AP MLD.

Alternatively, the client device 110 can send an indication in a management frame or action frame (e.g., a UHR Link Reconfiguration Notify frame) that the client device 110 is ready to receive traffic for all TIDs, for example using a flag such as “DL Data Completed for All TIDs.” In other embodiments, readiness to receive traffic for all TIDs is a default behavior that does not require signaling. When the target AP MLD receives this indication, it understands that the client device 110 has completed DL data drain for all TIDs with the serving AP MLD (with or without explicit indication in the frame) and that the target AP MLD can send DL data (and trigger for UL data) to the client device 110 for any TID on the active links. This approach simplifies signaling when the client device 110 is ready for all traffic types, avoiding the need to enumerate individual TIDs or ACs.

### Default Behaviors

Furthermore, the client device 110 and APs can follow default behaviors when not indicated otherwise based on the client signaling described above. By default, all added links with the target AP MLD are considered to be in power save mode (PM=1) and in doze state. In some embodiments, the client device 110 and the target AP MLD may negotiate a TTLM during the roaming preparation phase or roaming execution phase, establishing a non-default TTLM that specifies which TIDs are permitted for exchange on which active links. This negotiated mapping overrides the default all-to-all mapping (where all TIDs are mapped to all added links with the target AP MLD) and enables more granular traffic management during and after the roaming execution.

The target AP MLD does not start DL transmissions on any added links until it receives an UL transmission from the client device 110. The client device 110 sends an UL transmission to the target AP MLD, which indicates PM=0 for one or more links (e.g., using cross-link PM indication). The UL transmission may be needed to signal that client device 110 is done performing DL data draining from the previous serving AP MLD. By default, all TIDs are mapped to all added links with the target AP MLD, unless a new TTLM is established during roaming exchange or afterwards with the target AP MLD. Once one or more links are indicated as active (either with PM=0 or PM=1 but in awake state), the target AP MLD can deliver MPDUs for all mapped TIDs on those active links.

A link with PM=1 (power save mode) can be in either the doze state or the awake state. When a link is in PM=1 but in the awake state, the client device 110 is awake on that link and can receive transmissions, even though the link remains in power save mode. The awake state may occur, for example, when the client device 110 wakes up to receive buffered frames, wakes up to transmit UL traffic, or wakes up during certain power save delivery mechanisms. The target AP can determine that the client device 110 is in PM=1 but in awake state based on client device activity (e.g. because the client device 110 just transmitted to the AP) and then can transmit to the client device 110 on links that are in the awake state, regardless of whether PM is set to 0 or 1.

### Example Signal Process

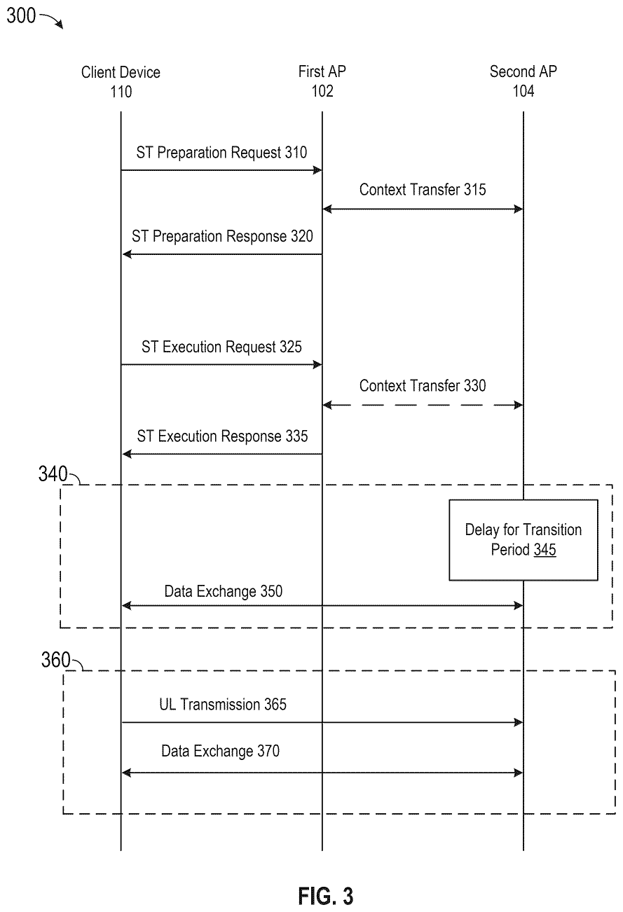

FIG. 3 is a message exchange diagram illustrating a procedure 300 for client signaling to target APs for seamless roaming. The illustrated procedure 300 shows communications between the client device 110, the first AP 102 (serving AP), and the second AP 104 (target AP) during a seamless roaming process that incorporates the client signaling mechanisms described above.

At some point prior to the message exchanges illustrated in FIG. 3, the client device 110 may determine to initiate a seamless roaming process. Initiating a seamless roaming process by the client device 110 may be triggered upon receiving a report from the first AP 102. Such report may be generated based on observed network conditions and parameters associated with the quality of connection of the client device 110 with the first AP 102 and/or other APs that are available. Alternatively, the client device 110 may determine to initiate seamless roaming based on RSSI measurements, trajectory predictions, BSS load, or other factors. Upon making this determination, the client device 110 may optionally perform initial signaling exchange with the first AP 102, such as requesting a Neighbor Report from the first AP 102 that includes identification of several available target APs.

Once the client device 110 determines to initiate seamless roaming, the client device 110 sends an ST preparation request to the first AP 102 in stage 310 to prepare one or more target APs by adding one or more links for roaming. The ST preparation request in stage 310 may indicate which links are available immediately, which links are available after a transition time period, which links will be available only after the client device 110 sends an UL transmission, and/or which TIDs or ACs are ready for DL and UL exchange after roaming execution. This enables the client device 110 to provide the target AP with the link availability and readiness information described above during the roaming preparation phase.

The ST preparation request may be implemented as a UHR Link Reconfiguration Request frame (e.g., with a specific Type value) or another signaling frame. For example, the UHR Link Reconfiguration Request may include one or more Reconfiguration ML elements indicating links to be added or setup with one or more candidate target AP MLDs along with (optionally) a preference order of desired candidates. The ST preparation request may further other roaming related indication and parameters such as a preparation indication, a Roaming SN, a context transfer indication indicating the set of contexts to be transferred, a resource reservation request, a context negotiation request, and/or other roaming context information.

After receiving the ST preparation request in stage 310, the first AP 102 may determine a final list of candidate target APs. This list may include the second AP 104 and potentially other target APs. Once the list is determined, the first AP 102 performs context transfer in exchange 315 with the candidate target APs (including the second AP 104) to transfer one or more static context parameters and reserve resources on the candidate target APs, and/or to perform negotiation of one or more static context parameters with the candidate target APs and to setup link(s) with the candidate target APs.

Importantly, the context transfer can include information indicating which links are available immediately, which links are available after a transition time period, which links will be available only after the client device 110 sends an UL transmission, and/or which TIDs or ACs are ready to be transmitted from the target AP MLD after roaming execution. Thus, the target AP (the second AP 104) receives the client signaling for link availability through the serving AP (first AP 102) during the roaming preparation phase.

The context transfer may also include transfer of near static context (or any selected context information) to one or more candidate target APs for roaming in the future, pre-setting up links on one or more candidate target APs (with the links not yet activated and 802.1x port not yet open for data transfer), and optional resource reservation for one or more resources on the candidate target APs for a time period (such as a Roaming Execution Timer duration). The resources reserved may include pre-assignment of setup links for the client device 110, reserving QoS resources for one or more SCS streams as requested by the client device 110 or selected by the first AP 102, reserving resources for TWT agreements (either existing TWT agreements that are requested to be transferred to specific links or new TWT agreements that are requested to be negotiated), reserving Block Acknowledgment resources, and/or reserving any other resources requested by the client device 110 or selected by the first AP 102. The context transferred may include parameters related to block acknowledgement agreements setup for the client device 110, SCS streams setup for the client device 110, MSCS streams setup for the client device 110, TWT agreements setup for the client device 110, TTLM agreements setup for the client device 110, security association context associated with the client device 110, capabilities of the client device 110, and/or other context information. The static context to be transferred to candidate target APs may be specified by the client device 110 and the first AP 102 (negotiated between them).

Following the context transfer in exchange 315, the first AP 102 sends an ST preparation response to the client device 110 in stage 320. The ST preparation response may include an indication of one or more candidate target APs (such as a list of candidate target APs that may be listed in preference order) that are prepared for roaming, an indication of a set of one or more static context parameters that were transferred to the candidate target APs, an indication of one or more context parameters that were negotiated with the candidate target APs, an indication of resources reserved at the candidate target APs, an Association Identifier (AID) assigned to the client device 110, and/or a Roaming Allowance Duration (RAD) or Roaming Execution Timer value.

In embodiments where a UHR Link Reconfiguration Request is used for roaming preparation, a corresponding UHR Link Reconfiguration Response may include ML element(s) (e.g., Basic Multi-link element or Reconfiguration ML element) for one or more target APs that are prepared and roaming context information that includes one or more of status (e.g., accept/reject) for roaming preparation, a roaming preparation indication, a Roaming SN, context transfer indication that indicates the set of context that were transferred, context negotiation indication that indicates one or more context parameters that were negotiated with the candidate target APs, resource reservation indication indicating the set of resources reserved, RAD/Roaming Execution Timer, and/or other information. The Roaming SN may be used to tie the roaming preparation phase with a subsequent roaming execution phase. If at least one candidate target AP (the second AP 104 in the illustrated embodiment) accepts the ST preparation request, the preparation phase is considered successful. Once the ST preparation response is received by the client device 110, the roaming preparation phase may be considered complete.

Thereafter, the client device 110 may determine a target AP to roam to from among the list of candidate target APs that are prepared for SMD roaming using exchanges described in stage 310 and stage 320. For example, the client device 110 may select the second AP 104 as the target AP to roam to. This determination may be based on RSSI measurements, location and trajectory information, channel load observations, preference order provided in the ST preparation response, and/or other factors. Once the client device 110 determines the target AP, the roaming execution phase may be triggered when the client device 110 sends an ST execution request to the first AP 102 in stage 325.

Using the ST execution request, the client device 110 may send a roaming execution request (e.g., an Add Link Request, a UHR Link Reconfiguration Request, etc.) to the first AP 102 to request roaming execution to the selected target AP (the second AP 104). The ST execution request may include roaming context information that includes one or more of a field for execution indication, a Roaming SN to tie the roaming execution phase with the roaming preparation phase, a context transfer indication indicating set of (dynamic) context to be transferred, context negotiation indication that indicates one or more context parameters to negotiate with the target AP, and/or other information.

In certain embodiments, the ST execution request may indicate which links are available immediately, which links are available after a transition time period, which links will be available only after the client device 110 sends an UL transmission, and/or which TIDs or ACs are ready to be transmitted from the target AP MLD after roaming execution. Therefore, the client device 110 can signal link availability via the ST preparation request in stage 310 and/or the ST execution request in stage 325, providing flexibility in when the link availability information is communicated to the target AP.

In certain embodiments, the roaming process may include the client device 110 sending a roaming request directly to the target AP. For example, the client device 110 can send a roaming request to the second AP 104 that indicates which links are available after a transition time period, which links will be available only after the client device 110 sends an UL transmission, and/or which TIDs or ACs are ready to be transmitted from the target AP MLD after roaming execution.

After the first AP 102 receives the ST execution request in stage 325, optional context transfer in exchange 330 may take place between the first AP 102 and the target AP (the second AP 104). This exchange may be performed according to any known or to be developed signaling procedure whereby the first AP 102 confirms the roaming with the selected target AP and exchanges dynamic context (e.g., SN and/or Packet Number (PN)) with the selected target AP. During the dynamic context transfer, in parallel, the target AP (the second AP 104) may initiate a Distribution System (DS) mapping change to switch the data path for the client device 110 from the first AP 102 to the second AP 104. The DS mapping change may be completed via signaling exchange between the second AP 104 and the DS, enabling the network to route data traffic for the client device 110 to the second AP 104 rather than the first AP 102.

In certain embodiments, the context transferred in exchange 330 includes information indicating which links are available immediately, which links are available after a transition time period, which links will be available only after the client device 110 sends an UL transmission, and/or which TIDs or ACs are ready to be transmitted from the target AP MLD after roaming execution. Thus, the second AP 104 receives the link availability information during the dynamic context transfer if it was not already provided during the static context transfer in exchange 315.

The first AP 102 sends an ST execution response in stage 335 to the client device 110 to confirm that roaming execution and dynamic context transfer as part of that process is complete. The ST execution response may be implemented as an Add Link Response, a UHR Link Reconfiguration Response, or other signaling frame. The ST execution response may include roaming context information such as information indicating status of the roaming execution (e.g., accept/reject), an execution phase indication, a Roaming SN, a context transfer indication indicating set of context that were transferred to the target AP, Group Keys of the links setup with the target AP, and/or other information.

Following the ST execution response in stage 335, the first AP 102 may optionally cancel resources reserved on other candidate target APs (which occurred along with static context transfer during the context transfer in exchange 315). Alternatively, the resource reservation (and links setup) on other candidate target APs can expire automatically (e.g., upon expiration of a timer which may be the same or different than the RAD).

With the ST execution completed, the procedure 300 can comprise exchange process 340 and/or exchange process 360. Either exchange process can be performed for each of the one or more links the client device 110 has setup with the second AP 104, depending on the link availability signaling provided by the client device 110.

In exchange process 340, the second AP 104 optionally performs a delay at stage 345 for the length of an indicated transition time period. This delay corresponds to the embodiment where the client device 110 indicated that one or more links would be available after a transition time period, enabling the client device 110 to reconfigure its radio resources before the second AP 104 begins DL transmissions. After the delay at stage 345, or immediately after the ST execution stage is completed (if no transition time period was indicated), the client device 110 and the second AP 104 can perform a data exchange at stage 350, including DL transmissions and triggered UL transmissions to the client device 110 on the available link(s).

In exchange process 360, the second AP 104 does not send DL transmissions (and triggered UL transmissions) until the client device 110 sends an UL transmission at stage 365. This corresponds to the embodiment where the client device 110 indicated that one or more links would be available only after the client device 110 sends an UL transmission signaling readiness. This also corresponds to the default behavior where all added links on the target AP MLD are considered in power save mode (PM=1) until explicitly indicated otherwise by the client device 110. The UL transmission at stage 365 may be an UL QoS data frame, UL QoS null frame, an UL management frame or action frame (such as a UHR Link Reconfiguration Notify frame with a specific Type value), or other management frame or action frame that signals PM=0 for one or more links (e.g., using on-link or cross-link PM signaling) and/or indicates which links are ready for DL transmissions and triggered UL (e.g., by indicating that the client device 110 has completed DL data drain from the previous serving AP MLD and is ready to receive transmissions from the target AP MLD). Following the UL transmission at stage 365, the client device 110 and the second AP 104 can perform a data exchange at stage 370, including DL transmissions to the client device 110 on the indicated link(s).

In embodiments where the client device 110 signaled specific TIDs or ACs that are ready for exchange with the target AP MLD, the client device 110 may signal the set of these TIDs or ACs in a UL transmission sent to the target AP MLD (e.g., during the UL transmission at stage 365), and the data exchange at stage 350 and/or stage 370 may be limited to those specific TIDs or ACs initially. For example, the client device may signal in an UL management frame such as a UHR Link Reconfiguration Notify frame (with a specific Type value) the list of TIDs or ACs for which it is ready for DL (and triggered UL) exchange with the target AP. Additional TIDs or ACs may become available for DL transmissions as the client device 110 sends additional signaling (e.g., updated TID/AC bitmaps in A-Control fields, TTLM Request frames, a UHR Link Reconfiguration Notify frame, etc.) indicating readiness for additional traffic types (TIDs or ACs) for DL (and triggered UL) transmissions.

### Methods

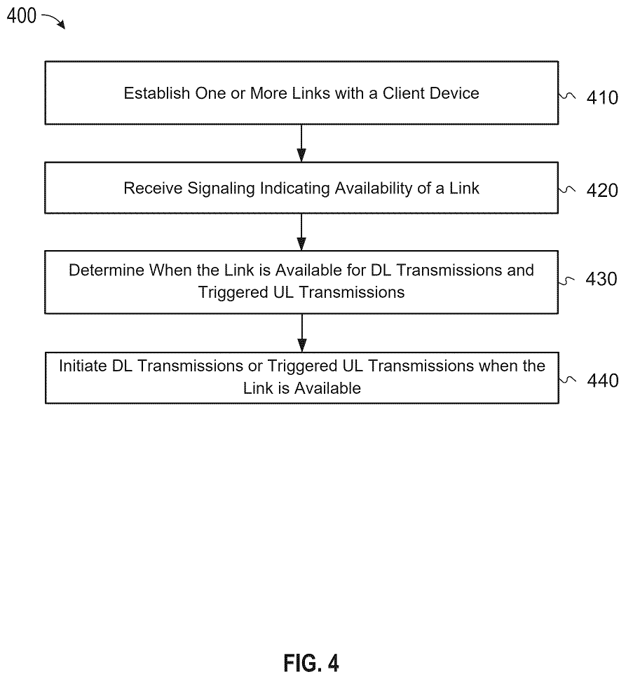

FIG. 4 is a flowchart illustrating a method 400 for client signaling to a target AP for seamless roaming. The method 400 is performed by a target AP MLD (such as the second AP 104) and enables the target AP MLD to determine when one or more links with a client device (such as the client device 110) are available for DL transmissions (and triggered UL) during a seamless roaming procedure.

At stage 410, the target AP establishes one or more links with a client device for roaming to the target AP. The links are configured in a power save mode by default, meaning that each link has a power management state of PM=1 (and may be in a doze state). The establishment of the one or more links may occur during a roaming preparation phase, where a serving AP (such as the first AP 102) transfers context to the target AP and pre-establishes links between the client device and the target AP. Alternatively or additionally, links may be established during a roaming execution phase when the client device transitions from the serving AP to the target AP. The one or more links may operate on various frequency bands and may include links on the same channels as links with the serving AP or on different channels requiring radio reconfiguration by the client device.

At stage 420, the target AP receives signaling indicating availability of a link of the one or more links for DL transmissions to the client device and triggered UL. The signaling enables the target AP to understand when the link is ready for DL transmissions, addressing the problem that by default all added links are in power save mode and in the doze state.

The signaling may be received through various mechanisms depending on the embodiment. In some embodiments, the signaling is received via context transfer from the serving AP during the roaming preparation phase or roaming execution phase. For example, the client device may include availability information in an ST preparation request or ST execution request sent to the serving AP, which then conveys this information to the target AP through context transfer. In other embodiments, the signaling is received directly from the client device during roaming or after a roaming execution is complete.

The signaling may take various forms depending on the specific availability indication provided by the client device. In some embodiments, the signaling comprises an UL transmission comprising a field that indicates a power save mode status for the one or more links. In other embodiments, the signaling comprises a link ID bitmap field that indicates the power save mode status for the one or more links, where bits set to 1 may indicate links that are available and bits set to 0 may indicate links that require further signaling before becoming available. In further embodiments, the signaling comprises a reconfiguration ML element that indicates the power save mode status for the one or more links. In yet other embodiments, the signaling comprises one or more link IDs that indicate the power save mode status for the one or more links.

The content of the signaling may indicate different availability scenarios. In some embodiments, the signaling indicates that the target AP should defer DL transmissions (and triggered UL) on the link until receiving an UL transmission from the client device. This enables the client device to control exactly when DL transmissions begin by sending the UL transmission when the client device is ready. In other embodiments, the signaling indicates that the link is available immediately after a roaming execution wherein the client device roams to the target AP. This may occur, for example, when the link operates on the same channel as a link with the serving AP, enabling the client device to immediately receive transmissions without radio reconfiguration. In further embodiments, the signaling indicates that the link is available after a transition time period following the roaming execution. The transition time period accounts for the time needed by the client device to reconfigure its radio resources to listen to the link.

In additional embodiments, the signaling indicates one or more TIDs or one or more ACs for which the client device is ready to receive DL transmissions (and triggered UL). This TID/AC-specific signaling enables the client device to indicate readiness for some traffic types while still receiving other traffic types from the serving AP or while not yet ready to receive certain traffic types from the target AP.

At stage 430, the target AP determines, based on the signaling received in stage 420, when the link is available for DL transmissions and triggered UL. The determination process varies depending on the type of availability indication provided in the signaling.

In embodiments where the signaling indicates that the target AP should defer DL transmissions on the link until receiving an UL transmission from the client device, determining when the link is available for DL transmissions and triggered UL comprises receiving the UL transmission from the client device and determining the link is available based on receiving the UL transmission. The UL transmission may comprise, for example, an UL QoS data frame indicating a power management state of PM=0 for the link using on-link or cross-link PM indication, an UL QoS null frame indicating PM=0 for the link using on-link or cross-link PM indication in an A-Control field, a UHR Link Reconfiguration Notify frame indicating that the client device has completed DL data drain with the serving AP, or another management frame indicating that the link is ready for DL transmissions and triggered UL.

In embodiments where the signaling indicates that the link is available immediately after a roaming transition/execution wherein the client device roams to the target AP, determining when the link is available is based on the roaming execution completing. The target AP may determine that the roaming execution is complete based on completing dynamic context transfer with the serving AP, receiving confirmation that the DS mapping has been updated, or other indicators that the roaming execution phase has completed.

In embodiments where the signaling indicates that the link is available after a transition time period following a roaming execution, determining when the link is available comprises delaying DL transmissions and triggered UL until expiration of the transition time period. The target AP may start a timer upon completion of the roaming execution (for example, after sending a roaming execution response) and wait for the timer to expire before determining that the link is available. The transition time period may be specified as a single value applicable to all links or as individual values per link, enabling different links to become available at different times.

In embodiments where the client device has multiple links with different availability characteristics, the target AP may perform the determination process separately for each link based on the specific availability indication for that link. For example, a first link may be determined to be available immediately after the roaming execution completes, while a second link may be determined to be available only after receiving an UL transmission from the client device.

At stage 440, the target AP initiates DL transmissions and/or triggered UL to the client device on the link after determining the link is available. Initiating DL transmissions enables the target AP to begin communicating with the client device at the appropriate time, avoiding wasted transmission attempts before the client device is ready and minimizing roaming latency by beginning transmissions as soon as the client device is ready.

In embodiments where the signaling indicates one or more specific TIDs or ACs for which the client device is ready to receive DL transmissions and triggered UL, initiating DL transmissions and triggered UL comprises transmitting data for the one or more TIDs or the one or more ACs to the client device. The target AP transmits only MPDUs corresponding to the indicated TIDs or ACs and defers DL transmissions for other TIDs or ACs not indicated in the signaling until receiving additional signaling indicating that the client device is ready to receive DL transmissions for those TIDs or ACs. The additional signaling may comprise, for example, updated TID/AC bitmaps in A-Control fields of subsequent UL frames, TTLM Request frames indicating additional TIDs that are ready, or an indication that all TIDs are ready (such as a “DL Data Completed for All TIDs” flag in a UHR Link Reconfiguration Notify frame) or indication in the UHR Link Reconfiguration Notify frame that additional TIDs are ready for DL (and triggered UL) transmissions. In some embodiments client device may provide separate signaling to indicate link availability for DL transmissions and UL transmissions.

The DL transmissions initiated at stage 440 enable seamless roaming by ensuring that the target AP begins transmissions when the client device is ready to receive them, thereby maintaining continuous connectivity and quality of service during the roaming execution. The method 400 may be performed for each of multiple links established between the target AP and the client device, with each link potentially having different availability timing based on the signaling provided by the client device.

Following stage 440, the target AP continues data communications with the client device on the link and any other available links. As additional links become available (for example, after receiving UL transmissions indicating readiness or after expiration of transition time periods), the target AP may begin DL transmissions on those additional links as well. Similarly, as the client device signals readiness for additional TIDs or ACs, the target AP may begin transmitting data for those additional traffic types.

### Systems

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for providing client signaling to target APs for seamless roaming. Computing device 500, for example, may provide an operating environment for the first AP 102, the second AP 104, the client device 110, the controller 120, and the like. The first AP 102, the second AP 104, the client device 110, the controller 120, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 500 on the single integrated circuit (chip).

FIG. 6 illustrates an implementation of a communications device 600 that may implement one or more of the first AP 102, the second AP 104, the client device 110, the controller 120, etc. In various implementations, the communications device 600 may comprise a logic circuit. The logic circuit may include physical circuits to perform operations described for one or more of the first AP 102, the second AP 104, the client device 110, the controller 120, etc., for example. As shown in FIG. 6, the communications device 600 may include one or more of, but is not limited to, a radio interface 610, baseband circuitry 630, and/or the computing device 500.

The communications device 600 may implement some or all of the structures and/or operations for the first AP 102, the second AP 104, the client device 110, the controller 120, etc., storage medium, and logic circuit in a single computing entity, such as entirely within a single device. Alternatively, the communications device 600 may distribute portions of the structure and/or operations using a distributed system architecture, such as a client station server architecture, a peer-to-peer architecture, a master-slave architecture, etc.

A radio interface 610, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 610 may include, for example, a receiver 615 and/or a transmitter 620. The radio interface 610 may include bias controls, a crystal oscillator, and/or one or more antennas 625. In additional or alternative configurations, the radio interface 610 may use oscillators and/or one or more filters, as desired.

The baseband circuitry 630 may communicate with the radio interface 610 to process, receive, and/or transmit signals and may include, for example, an Analog-To-Digital Converter (ADC) for down converting received signals with a Digital-To-Analog Converter (DAC) 635 for up converting signals for transmission. Further, the baseband circuitry 630 may include a baseband or PHY layer processing circuit for the PHY link layer processing of respective receive/transmit signals. Baseband circuitry 630 may include, for example, a MAC processing circuit 640 for MAC/data link layer processing. Baseband circuitry 630 may include a memory controller for communicating with MAC processing circuit 640 and/or a computing device 500, for example, via one or more interfaces 645.

In some configurations, PHY processing circuit may include a frame construction and/or detection module, in combination with additional circuitry such as a buffer memory, to construct and/or deconstruct communication frames. Alternatively or in addition, MAC processing circuit 640 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
establishing, by a target access point (AP), one or more links with a client device for roaming to the target AP, wherein the one or more links are configured in a power save mode by default;
receiving, by the target AP, signaling indicating availability of a link of the one or more links for transmissions to the client device;
determining, by the target AP and based on the signaling, when the link is available for transmissions; and
initiating, by the target AP, transmissions to the client device on the link after determining the link is available.

2. The method of claim 1, wherein the transmissions to the client device include one or both of downlink (DL) transmissions and triggered uplink (UL) transmissions.

3. The method of claim 1, wherein
the signaling indicates the target AP should defer transmissions on the link until receiving an UL transmission from the client device; and
determining when the link is available for transmissions comprises:
receiving the UL transmission from the client device, and
determining the link is available based on receiving the UL transmission.

4. The method of claim 3, wherein the UL transmission comprises any one of (i) an UL QoS data frame, (ii) an UL QoS null frame, or (iii) an UL management frame.

5. The method of claim 3, wherein the UL transmission indicates availability of the link for transmissions via on-link power management signaling or cross-link power management signaling.

6. The method of claim 3, wherein the UL transmission comprises an ultra high reliability link reconfiguration notify frame indicating availability of the link for transmissions.

7. The method of claim 1, wherein the signaling comprises any one of (i) a roaming request comprising a field that indicates a power save mode status for the one or more links, (ii) a link identifier bitmap field that indicates the power save mode status for the one or more links, (iii) a reconfiguration multi-link element that indicates the power save mode status for the one or more links, or (iv) one or more link identifiers that indicate the power save mode status for the one or more links.

8. The method of claim 1, wherein:
the signaling indicates the link is available immediately after a roaming execution wherein the client device roams to the target AP; and
determining when the link is available is based on the roaming execution completing.

9. The method of claim 1, wherein:
the signaling indicates the link is available after a transition time period following a roaming execution wherein the client device roams to the target AP; and
determining when the link is available comprises delaying transmissions until expiration of the transition time period.

10. The method of claim 1, wherein:
the signaling indicates one or more Traffic Identifiers (TIDs) or one or more Access Categories (ACs) for which the client device is ready to receive transmissions; and
initiating transmissions comprises transmitting data for the one or more TIDs or the one or more ACs to the client device.

11. A system comprising:
a memory storage; and
a processing unit coupled to the memory storage, wherein the processing unit is operative to:
establish one or more links with a client device for roaming, wherein the one or more links are configured in a power save mode by default;
receive signaling indicating availability of a link of the one or more links for transmissions to the client device;
determine, based on the signaling, when the link is available for transmissions; and
initiate transmissions to the client device on the link after determining the link is available.

12. The system of claim 11, wherein the transmissions to the client device include one or both of downlink (DL) transmissions and triggered uplink (UL) transmissions.

13. The system of claim 11, wherein:
the signaling indicates to defer transmissions on the link until receiving an UL transmission from the client device; and
to determine when the link is available for transmissions comprises to:
receive the UL transmission from the client device, and
determine the link is available based on receiving the UL transmission.

14. The system of claim 13, wherein the UL transmission comprises any one of (i) an UL QoS data frame, (ii) an UL QoS null frame, or (iii) an UL management frame.

15. The system of claim 13, wherein the UL transmission indicates availability of the link for transmissions via on-link power management signaling or cross-link power management signaling.

16. The system of claim 11, wherein:
wherein the signaling comprises any one of (i) a roaming request comprising a field that indicates a power save mode status for the one or more links, (ii) a link identifier bitmap field that indicates the power save mode status for the one or more links, (iii) a reconfiguration multi-link element that indicates the power save mode status for the one or more links, or (iv) one or more link identifiers that indicate the power save mode status for the one or more links.

17. The system of claim 11, wherein:
the signaling indicates the link is available immediately after a roaming execution of the client device; and
to determine when the link is available is based on the roaming execution completing.

18. The system of claim 11, wherein:
the signaling indicates the link is available after a transition time period following a roaming execution of the client device roams; and
to determine when the link is available comprises delaying transmissions until expiration of the transition time period.

19. The system of claim 11, wherein:
the signaling indicates one or more Traffic Identifiers (TIDs) or one or more Access Categories (ACs) for which the client device is ready to receive transmissions; and
to initiate transmissions comprises to transmit data for the one or more TIDs or the one or more ACs to the client device.

20. A non-transitory computer-readable medium that stores a set of instructions which when executed perform a method comprising:
establishing one or more links with a client device for roaming, wherein the one or more links are configured in a power save mode by default;
receiving signaling indicating availability of a link of the one or more links for transmissions to the client device;
determining, and based on the signaling, when the link is available for transmissions; and
initiating transmissions to the client device on the link after determining the link is available.
